(19) United States
(12) Patent Application Publication
(10) Pub. No.: US 2011/0147449 A1
(43) Pub. Date: Jun. 23, 2011

(54) PROCESSING METHOD FOR ELECTRONIC EXPENSE CERTIFICATION

(76) Inventor: Cheng-Han LU, Taipei City (TW)

(21) Appl. No.: 12/646,646

(22) Filed: Dec. 23, 2009

(51) Int. Cl. G06F 17/00

(52) U.S. Cl. 235/375

(57) ABSTRACT

A processing method for an electronic expense certification includes steps of: displaying a 2D barcode on a mobile device, reading the 2D barcode by a first 2D barcode reader at a first time period to generate a first time data, reading the 2D barcode by a second 2D barcode reader at a second time period to generate a second time data, and generating an expense data according to the first and second time data.

### BACKGROUND OF THE INVENTION

1. Field of Invention

The present invention relates to a processing method for a certification and, in particular, to a processing method for an electronic expense certification.

2. Related Art

Using a credit card or debit/prepaid card to purchase a bill is a common way to proceed the payment without using cash. No matter the credit or debit/prepaid card is read by a contact or non-contact device, this kind of payment needs a “card”. That is, the buyer must get at least one “credit or debit/prepaid card” in advance, so that he/she can purchase the bill with the card.

To use a credit card to pay a bill is a payment without using cash, and it is simply known as a loan service. The credit card is issued by a bank or a credit card issuer depending on the credit and financial ability of the user. When the user pays the expense by a credit card, he/she does not have to pay it with cash, and this expense can be paid based on the later credit card bill.

Recently, the debit/prepaid card is embedded with an IC chip, which mainly includes an I/O interface and a memory. Regarding to a prepaid card, the user can buy a debit amount and store it in the prepaid card, and the memory of the prepaid card can record the stored debit amount so that the user can use this prepaid card to purchase the expense later. This kind of card is suitable for the application of small amount expense such as shopping in stores, taking transportation vehicles, paying parking bills, etc.

However, the credit card, debit card and prepaid card are all physical cards for identification. If this card is lost or destroyed, the user must report the loss of the card to the card issuers and wait another new-issued card. This action will result to an additional charge for the new-issued card, and it also needs a couple days to reissue this new card.

Therefore, it is an important subject of the present invention to provide a processing method for an electronic expense certification that is more convenient and cheaper.

### SUMMARY OF THE INVENTION

In view of the foregoing subject, the present invention is to provide a processing method for an electronic expense certification that is more convenient and cheaper.

To achieve the above, the present invention discloses a processing method for an electronic expense certification. The processing method includes the following steps of displaying a 2D barcode on a mobile device, reading the 2D barcode displayed on the mobile device by a first 2D barcode reader at a first time period to generate a first time data, reading the 2D barcode displayed on the mobile device by a second 2D barcode reader at a second time period to generate a second time data, and generating an expense data according to the first time data and the second time data.

In addition, the present invention also discloses another processing method for an electronic expense certification. This processing method includes the following steps of: displaying a 2D barcode on a mobile device, reading the 2D barcode displayed on the mobile device by a 2D barcode reader at a first time period to generate a first time data, reading the 2D barcode displayed on the mobile device by the 2D barcode reader at a second time period to generate a second time data, and generating an expense data according to the first time data and the second time data.

In one aspect, the processing method further includes a step of accumulating the expense data in a debit data.

In one aspect, the processing method may further include a step of issuing a debit note according to the debit data. Otherwise, the processing method may further include a step of deducting money from an account corresponding to the 2D barcode according to the debit data. Alternatively, the processing method may further include a step of adding the debit data to a credit card bill.

In one aspect, the processing method may further include a step of presetting an expense top limit.

In one aspect, the processing method may further comprising the steps of determining whether a debit amount of the debit data is greater than an expense top limit or not, and generating a fail message when the debit amount is greater than the expense top limit.

In one aspect, the processing method may further include the steps of determining whether an expense amount of the expense data is greater than the expense top limit or not, and generating a fail message when the expense amount is greater than the expense top limit.

In one aspect, the processing method may further comprising the steps of determining whether a debit amount of the debit data is greater than an expense top limit or not, and transmitting another 2D barcode to the mobile device when the debit amount is greater than the expense top limit.

In one aspect, the processing method may further include the steps of determining whether an expense amount of the expense data is greater than the expense top limit or not, and transmitting another 2D barcode to the mobile device when the expense amount is greater than the expense top limit.

In one aspect, each of the first time data and the second time data includes a time record, and the expense data is generated according to the time records.

In one aspect, each of the first time data and the second time data comprises a location record, and the expense data is generated according to the location records.

As mentioned above, the processing method for an electronic expense certification of the present invention utilizes the 2D barcode as the electronic expense certification, and the 2D barcode can be displayed on a mobile device. Therefore, the user can operate the mobile device to display the 2D barcode and then utilize the 2D barcode to purchase his/her expense.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a flow chart showing a processing method for an electronic expense certification according to an embodiment of the present invention;

FIGS. 2A and 2B are schematic views of the system structures according to the embodiment of the present invention;

FIG. 3 is a flow chart showing a processing method for an electronic expense certification according to another embodiment of the present invention;

FIGS. 4A and 4B are schematic views of the system structures according to another embodiment of the present invention;

FIG. 5 is a schematic diagram showing the flows of the processing method for an electronic expense certification according to the embodiment of the present invention; and

FIG. 6 is a flow chart showing the detailed steps of the processing method for an electronic expense certification according to the embodiment of the present invention.

### DETAILED DESCRIPTION OF THE INVENTION

The present invention will be apparent from the following detailed description, which proceeds with reference to the accompanying drawings, wherein the same references relate to the same elements.

The 2D barcode is composed of many dots and bars, and it can carry a lot of information such as words, figures, voices, etc. Compared with the conventional 1D barcode, the 2D barcode has the advantages of larger information capacity, higher reliability, superior security, etc. In addition, the 2D barcode includes the error checking code or error correction code, so that even the printed or displayed 2D barcode is not clear or damaged, the barcode reader can realize whether the 2D barcode is damaged or not according to the error checking code or error correction code. Furthermore, the error correction code can help the barcode reader to recover the damaged part of the 2D barcode, thereby correctly reading the entire information carried in the 2D barcode.

The 2D barcode can be in a QR-code format or in other format.

Since the 2D barcode has the advantages of higher reliability, superior security, and etc., it is suitable for an electronic expense certification. In addition, the 2D barcode can be transmitted to the user by electronic communication, which can avoid the drawbacks of delivering and receiving the conventional physical certification such as the RF ID card, credit card, debit card, and etc. Therefore, the issue, reissue or renewal of the electronic expense certification as well as the applying thereof is not limited by the locations. Moreover, since the electronic expense certification is a virtual certification instead of a physical one, and it is transmitted to the user through electronic communication, the cost is much cheaper.

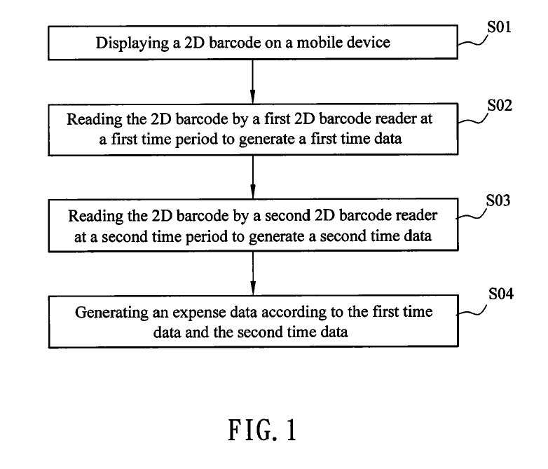

With reference to FIG. 1, the processing method for an electronic expense certification of 2D barcode includes the following steps S01 to S04.

Step S01 is to display a 2D barcode on a mobile device. In this case, the mobile device can be a cell phone or a PDA, which has a screen for displaying the 2D barcode.

In step S02, the 2D barcode displayed on the mobile device is read by a first 2D barcode reader at a first time period so as to generate a first time data.

In step S03, the 2D barcode displayed on the mobile device is read by a second 2D barcode reader at a second time period so as to generate a second time data.

The step S04 is to generate an expense data according to the first time data and the second time data.

Each of the first and second time data may include a time record, so that the expense data can be generated according to the time records. Alternatively, each of the first and second time data may include a location record, so that the expense data can be generated according to the location records. In addition, the expense data can be accumulated in a debit data.

The 2D barcode is used for certification only and it does not have the function of the prepaid card. In addition, the expense records are not record in the 2D barcode. If the mobile device or the 2D barcode is lost, the reissued 2D barcode can be rapidly transmitted to the user by electronic communication, and the lost 2D barcode becomes invalid at the same time.

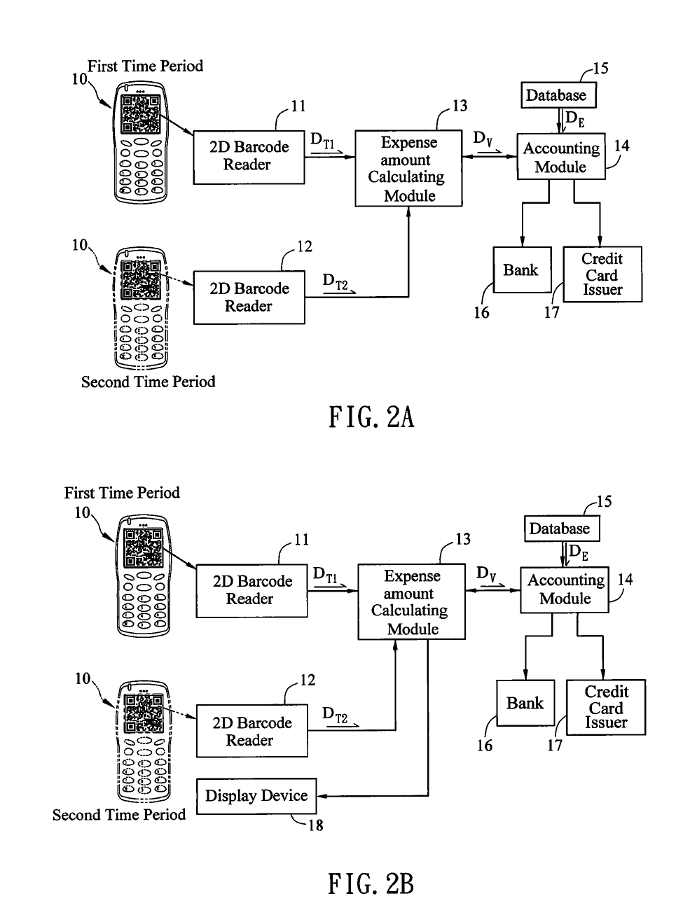

With reference to FIG. 2A, two 2D barcode readers 11 and 12 are configured at two different locations, respectively, and they are linked with an expense amount calculating module 13. The expense amount calculating module 13 can receive a first time data D_{T1} and a second time data D_{T2}, which are generated at different time periods, from the 2D barcode reader 11 and the 2D barcode reader 12, respectively. Then, the expense amount calculating module 13 generates an expense data D_{V} according to the received first and second time data D_{T1} and D_{T2}.

The expense data D_{V} is then transmitted to an accounting module 14, and the accounting module 14 can accumulate an expense amount of the expense data D_{V} in a debit data D_{E}. In this embodiment, the debit data D_{E} is stored in a database 15, so that the following debit process to the consumer can be performed according to the debit amount recorded in the debit data D_{E}.

The accounting module 14 can issue a notice containing the debit amount to the related organizations such as a bank 16, a credit card issuer 17, and etc. Then, the related organizations can issue the debit note or bill to the consumers so as to request the consumers to proceed the payment.

In this embodiment, the processing method for an electronic expense certification can issue a debit note including all or part of the accumulated expense amount. In addition, the processing method for an electronic expense certification may deduct money from an account corresponding to the 2D barcode according to the accumulated expense amount. Otherwise, the processing method for an electronic expense certification may add the accumulated expense amount to a credit card bill.

To be noted, this kind of processing method is suitable for the expense counting based on using times, time periods or distances.

Taking the transportation as an example, a user may get on a transportation vehicle at a first location and allow a 2D barcode reader to read the 2D barcode displayed on the mobile phone, and then he/she may get off the transportation vehicle at a second location and allow another 2D barcode reader to read the 2D barcode displayed on the mobile phone.

Taking the entertainment theater or parking lot as an example, a user may allow a 2D barcode reader located at the entrance to read the 2D barcode displayed on the mobile phone, and then allow another 2D barcode reader located at the exit to read the 2D barcode displayed on the mobile phone.

For example, each of the first and second time data includes a time record, and the expense data is generated according to the time records. This method is particularly suitable for the application based on time periods, such as the parking fee.

In addition, each of the first time data D_{T1} and the second time data D_{T2} may include a location record, and the expense data is generated according to the location records. This method is particularly suitable for the application based on distances, such as the fee for taking a transportation vehicle.

To be noted, no matter the first time data D_{T1} and the second time data D_{T2} include the time records or location records, they are both suitable for the application based on using times, such as the ticket fee for an entertainment show.

As shown in FIG. 2B, the current expense amount can be returned to a display device 18 located at the same place as the 2D barcode reader 12, so that the consumer and the vendor can realize the expense amount immediately.

In addition, the transaction fail message can also be returned to the display device 18. The transaction may be failed due to that the current expense amount is greater than the expense top limit or the accumulated expense amount (e.g. the debit amount) is greater than the expense top limit.

The expense top limit can be preset, and the types and presetting timing will be described hereinafter.

As mentioned above, the processing method for an electronic expense certification of the present invention can determine whether a debit amount of the debit data is greater than an expense top limit or not, and then generate a fail message when the debit amount is greater than the expense top limit. Otherwise, it can determine whether an expense amount of the expense data is greater than the expense top limit or not, and then generate a fail message when the expense amount is greater than the expense top limit. The details of these determining steps will be described in the following examples.

In another embodiment, the 2D barcode can be read by the same 2D barcode reader at different time periods.

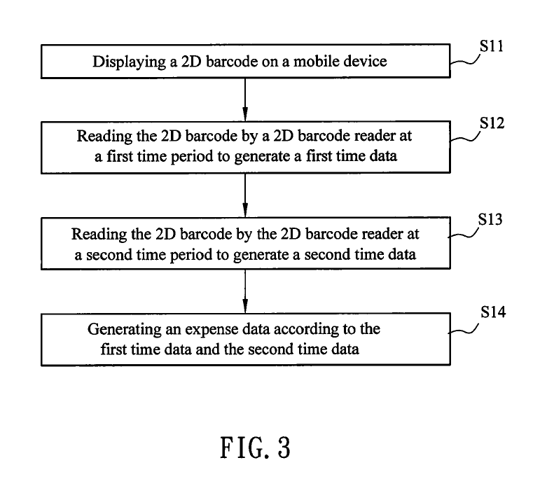

As shown in FIG. 3, the processing method for an electronic expense certification of 2D barcode includes the following steps S11 to S14.

Step S11 is to display a 2D barcode on a mobile device. In this case, the mobile device can be a cell phone or a PDA, which has a screen for displaying the 2D barcode.

In step S12, the 2D barcode displayed on the mobile device is read by a 2D barcode reader at a first time period so as to generate a first time data.

In step S13, the 2D barcode displayed on the mobile device is read by the same 2D barcode reader at a second time period so as to generate a second time data.

The step S14 is to generate an expense data according to the first time data and the second time data.

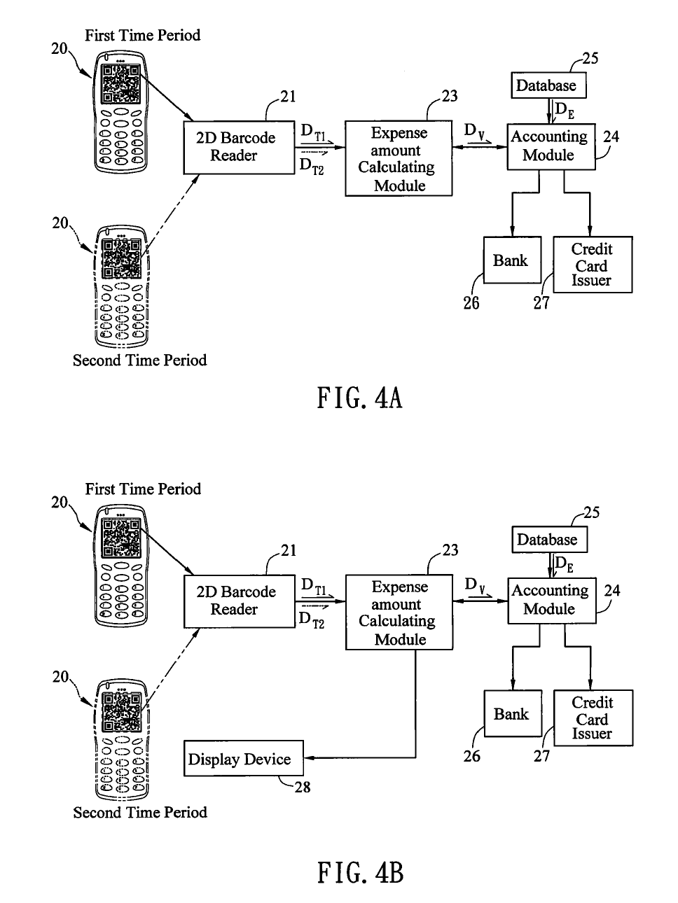

With reference to FIG. 4A, a 2D barcode reader 21 is configured and is linked with an expense amount calculating module 23. The expense amount calculating module 23 can receive a first time data D_{T1} and a second time data D_{T2}, which are generated at different time periods, from the 2D barcode reader 21. Then, the expense amount calculating module 23 generates an expense data D_{V} according to the received first and second time data D_{T1} and D_{T2}.

The expense data D_{V} is then transmitted to an accounting module 24, and the accounting module 24 can accumulate an expense amount of the expense data D_{V} in a debit data D_{E}. In this embodiment, the debit data D_{E} is stored in a database 25.

The accounting module 24 can issue a notice containing the debit data D_{E} to the related organizations such as a bank 26, a credit card issuer 27, and etc. Then, the related organizations can issue the debit note or bill to the consumers so as to request the consumers to proceed the payment.

Referring to FIG. 4B, the current expense amount can be returned to a display device 28 located at the same place as the 2D barcode reader 21, so that the consumer and the vendor can realize the expense amount immediately.

In addition, the transaction fail message can also be returned to the display device 28. The transaction may be failed due to that the current expense amount is greater than the expense top limit or the accumulated expense amount (e.g. the debit amount) is greater than the expense top limit.

Compared with the previous embodiment as shown in FIGS. 1, 2A and 2B, this embodiment of FIGS. 3 and 4 utilizes a single 2D barcode reader to read the 2D barcode at different time periods. Since the further variations and applications of this embodiment are similar to those of the previous embodiment of FIGS. 1, 2A and 2B, the detailed descriptions thereof will be omitted.

In order to make the present invention more comprehensive, the applying, using and processing steps of the electronic expense certification will be described with referring to the following examples.

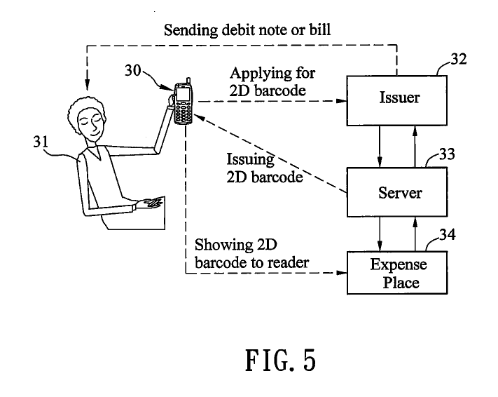

With reference to FIG. 5, a user 31 applies for an electronic expense certification of 2D barcode from an issuer 32. The issuer 32 is an organization for issuing the electronic expense certification such as a bank, a credit card issuer, and etc.

During the applying step, the user 31 may also deal an expense top limit with the issuer 32. For example, the issuer 32 may automatically preset a general expense top limit, or the user 31 may request a personal expense top limit according to his/her requirement.

In the embodiment, the expense top limit can be: (1) the top limit for a single expense, (2) the top limit for accumulated expense amount, or (3) the renewal timing of the 2D barcode certification.

The renewal timing of the 2D barcode certification will be described hereinbelow. For example, when the current single expense amount is greater than the expense top limit, the transaction of the current expense is still success and the 2D barcode certification must be renewed. That is, the old 2D barcode certification can not be used in the next transaction. Alternatively, when the accumulated expense amount is greater than the expense top limit, the transaction of the current expense is still success and the 2D barcode certification must be renewed. In both cases, the user must apply for a renewed 2D barcode certification for the next expense. In other words, the old 2D barcode certification is expired, and only the renewed one can be used in the next transaction.

The expense amount generated by the above-mentioned transaction will be accumulated on a debit amount, so that the issuer 32 can issue a debit note or bill to the user 31 for charging money with respect to the expenses.

The debit note or bill can be directly sent to the user 31 by, for example, mail or email, so that the user 31 can pay it according to the debit note or bill. Otherwise, the payment can be performed by deducting the debit amount from an account of the user 31. Or else, the debit amount can be added to a credit card bill of the user 31. To be noted, these payment methods can be determined according to the contract between the user 31 and the issuer 32 during the applying step.

In order to increase the transaction security with using the electronic expense certification, the 2D barcode electronic expense certification can be renewed based on at least one of the following situations. In the first situation, the 2D barcode electronic expense certification is renewed when the expense amount is greater than the expense top limit as mentioned above. In the second situation, the 2D barcode electronic expense certification is renewed automatically and periodically. In the third situation, the 2D barcode electronic expense certification is renewed according to the user's request. In the fourth situation, the 2D barcode electronic expense certification is renewed when the user reports that the old one is lost or damaged.

The renewal of the 2D barcode expense certification can be performed by issuing a new 2D barcode expense certification from a server 33 to a designated mobile device 30 of the user 31. After that, the next transaction will be failed if the user 31 shows the old 2D barcode expense certification, so that the user 31 must show the new one to make this transaction success.

After finishing the related settings, the issuer 32 will transmit the certification information to the server 33, so that the server 33 can generate a 2D barcode according to the received certification information and then transmit the 2D barcode to the designated mobile device 30 of the user 31 through the telecommunication system. For example, the 2D barcode can be transmitted to a cell phone with respect to a certain phone number by MMS (multimedia message service).

After receiving the 2D barcode, the user 31 can operate the mobile device 30 to display the 2D barcode on the screen of the mobile device 30, and then allow one or more 2D barcode readers configured at an expense place 34 to read the displayed 2D barcode. Then, the expense amount counting module of the server 33 or the expense place 34 can calculate the expense amount and then generate an expense data according to the result of reading the 2D barcode. The related processes are described in the previous embodiments, so the detailed descriptions will be omitted.

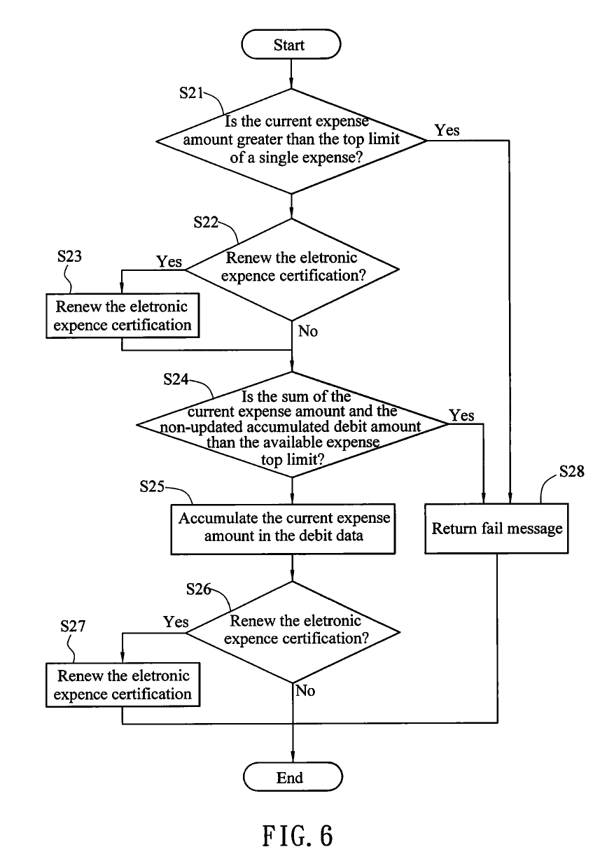

After receiving the current expense data, the server 33 can perform the steps as shown in FIG. 6 based on the preset settings. In this case, the server 33 may include an accounting module as described in the previous embodiment to process the expense data.

The step S21 is to determine whether the current expense amount is greater than the top limit of a single expense or not according to the expense data. If yes, the step S28 is then performed; otherwise, if the current expense amount is not greater than the top limit of a single expense, or if the top limit of a single expense is not existed, the step S22 is then performed.

The step S22 is to determine whether to renew the electronic expense certification based on, for example, determining whether the current expense amount is greater than a top limit for renewing the certification. If yes, the step S23 is then performed; otherwise, if no, the step S24 is then performed.

The step S23 is to renew the electronic expense certification, and then the step S24 is performed. The electronic expense certification can be renewed by transmitting a new 2D barcode to a designated mobile device of the user.

The step S24 is to determine whether the sum of the current expense amount and the non-updated accumulated debit amount is greater than the available expense top limit according to the expense data and the non-updated debit data. If yes, the step S28 is then performed; otherwise, if the sum of the current expense amount and the non-updated accumulated debit amount is greater than the available expense top limit, or if the available expense top limit is not existed, the step S25 is then performed.

The step S25 is to accumulate the current expense amount in the debit data according to the expense data, and then the step S26 is performed.

The step S26 is to determine whether to renew the electronic expense certification based on, for example, determining whether the debit amount is greater than a top limit for renewing the certification. If yes, the step S27 is then performed.

The step S27 is to renew the electronic expense certification. As mentioned above, the electronic expense certification can be renewed by transmitting a new 2D barcode to a designated mobile device of the user.

The step S28 is to return a fail message, which may include the reason for fail, the expense amount, and etc. In this case, the fail message can be returned to the display device configured at the expense place or the mobile device of the user.

In summary, the processing method for an electronic expense certification of the present invention utilizes the 2D barcode as the electronic expense certification, and the 2D barcode can be displayed on a mobile device. Therefore, the user can operate the mobile device to display the 2D barcode and then utilize the 2D barcode to purchase his/her expense.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A processing method for an electronic expense certification, comprising the following steps of:
displaying a 2D barcode on a mobile device;
reading the 2D barcode displayed on the mobile device by a first 2D barcode reader at a first time period to generate a first time data;
reading the 2D barcode displayed on the mobile device by a second 2D barcode reader at a second time period to generate a second time data; and
generating an expense data according to the first time data and the second time data.

2. The processing method according to claim 1, further comprising a step of:
accumulating the expense data in a debit data.

3. The processing method according to claim 1, further comprising a step of:
presetting an expense top limit.

4. The processing method according to claim 2, further comprising a step of:
issuing a debit note according to the debit data.

5. The processing method according to claim 2, further comprising a step of:
deducting money from an account corresponding to the 2D barcode according to the debit data.

6. The processing method according to claim 2, further comprising a step of:
adding the debit data to a credit card bill.

7. The processing method according to claim 3, further comprising the steps of:
determining whether an expense amount of the expense data is greater than the expense top limit or not; and
generating a fail message when the expense amount is greater than the expense top limit.

8. The processing method according to claim 2, further comprising the steps of:
determining whether a debit amount of the debit data is greater than an expense top limit or not; and
generating a fail message when the debit amount is greater than the expense top limit.

9. The processing method according to claim 1, wherein each of the first time data and the second time data comprises a time record, and the expense data is generated according to the time records.

10. The processing method according to claim 1, wherein each of the first time data and the second time data comprises a location record, and the expense data is generated according to the location records.

11. A processing method for an electronic expense certification, comprising the following steps of:
displaying a 2D barcode on a mobile device;
reading the 2D barcode displayed on the mobile device by a 2D barcode reader at a first time period to generate a first time data;
reading the 2D barcode displayed on the mobile device by the 2D barcode reader at a second time period to generate a second time data; and
generating an expense data according to the first time data and the second time data.

12. The processing method according to claim 11, further comprising a step of:
accumulating the expense data in a debit data.

13. The processing method according to claim 11, further comprising a step of:
presetting an expense top limit.

14. The processing method according to claim 12, further comprising a step of:
issuing a debit note according to the debit data.

15. The processing method according to claim 12, further comprising a step of:
deducting money from an account corresponding to the 2D barcode according to the debit data.

16. The processing method according to claim 12, further comprising a step of:
adding the debit data to a credit card bill.

17. The processing method according to claim 13, further comprising the steps of:
determining whether an expense amount of the expense data is greater than the expense top limit or not; and
generating a fail message when the expense amount is greater than the expense top limit.

18. The processing method according to claim 12, further comprising the steps of:
determining whether a debit amount of the debit data is greater than an expense top limit or not; and
generating a fail message when the debit amount is greater than the expense top limit.

19. The processing method according to claim 11, wherein each of the first time data and the second time data comprises a time record, and the expense data is generated according to the time records.

20. The processing method according to claim 11, wherein each of the first time data and the second time data comprises a location record, and the expense data is generated according to the location records.
